(19) United States
(12) Patent Application Publication
(10) Pub. No.: US 2004/0090533 A1
(43) Pub. Date: May 13, 2004

(54) System and method for video image capture

(76) Inventors: James C. Dow, Fort Collins, CO (US); Dan L. Dalton, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/291,931

(22) Filed: Nov. 11, 2002

(51) Int. Cl. H04N 5/225

(52) U.S. Cl. 348/220.1

(57) ABSTRACT

The present invention provides a digital camera with a first trigger and a separate, dedicated second trigger. The first trigger may be used to trigger the capture of still images. The second trigger may be used to record video images. Because the digital camera has a first trigger and a separate, dedicated second trigger, a user does not have to turn a mode dial or other mode selector to select between capturing a still image and capturing one or more video images. The first and second triggers may be assigned to other capture mode operations, including a sequence image capture mode and an audio capture mode.

### FIELD OF THE INVENTION

The present invention relates to video image capture and still image capture for a digital camera.

### BACKGOUND

In some instances, digital cameras support video image capture and still image capture. However, such cameras typically include a mode controller with which a user can change from a still capture mode to a video capture mode. A single still image capture trigger is used to capture still images in the still image capture mode and video images in the video capture mode. Thus, these types of cameras typically default to a capture of still images and force the user to change the modality of the camera prior to capturing video images. For example, a mechanical switch may be used to set the capture trigger in a still capture position or a video capture position, requiring the user to check the state of the switch before taking a picture or video.

Requiring the user to change the modality of the camera may distract the user from the subject on which the user is focused and cause confusion for the user. Also, changing modality may require a user to search through menu selections or change mechanical knobs. This may add additional confusion and delay the user's ability to immediately capture a still image or a video image. Therefore, systems and methods are desired in which a user may select still image capture and video image capture without first changing between a still capture mode and a video capture mode.

### SUMMARY OF THE INVENTION

In one aspect, the present invention is directed to a digital camera comprising a still image capture trigger configured to trigger still image capture and a video image capture trigger configured to trigger video image capture. The digital camera also includes an image sensor and a processing unit. The image sensor is configured to capture still image data when the still image capture trigger is triggered and to capture video image data when the video image capture trigger is triggered. The processing unit is configured to receive and to image process the still image data and the video image data.

In another aspect, the present invention is directed to a digital camera comprising a first trigger, a second trigger, and a processing unit. The first trigger is configured to enable triggering a first capture operation to capture first data. A second trigger is configured to enable triggering a second capture operation to capture second data. The processing unit is electronically coupled to the first trigger and the second trigger and is configured to initiate the first capture operation to capture the first data when the first trigger is triggered, to initiate the second capture operation to capture the second data when the second trigger is triggered, and to receive and to process the first data and the second data.

In still another aspect, the present invention is directed to a method for configuring a digital camera for capturing video images and at least one still image. The method comprises providing, on the digital camera, a still image capture trigger configured to enable triggering still image capture. The method includes providing, on the digital camera, a video image capture trigger separate from the still image capture trigger, the video image capture trigger configured to enable triggering video image capture. The method also includes providing, on the digital camera, an image sensor configured to capture still image data when the still image capture trigger is triggered and to capture video image data when the video image capture trigger is triggered. The method further includes providing, on the digital camera, a processing unit configured to receive and to image process the still image data and the video image data.

In yet another aspect, the present invention is directed to a method for operating a digital camera configured with a first capture trigger, a second capture trigger, an image sensor, and a processing unit. The method comprises capturing still image data at the image sensor for at least one still image upon trigger of the first capture trigger. Video image data is captured at the image sensor upon trigger of the second capture trigger. The still image data and the video image data are image processed with the processing unit.

### BRIEF DESCRIPTION OF THE DRAWINGS

FIG. 1 is a perspective view of the top and front of a digital camera in accordance with an embodiment of the present invention.

FIG. 2 is a perspective view of the top and back of a digital camera in accordance with an embodiment of the present invention.

FIG. 3 is a perspective view of the top and back of another digital camera in accordance with an embodiment of the present invention.

FIG. 4 is a block diagram electronic subsystems of a digital camera in accordance with an embodiment of the present invention.

### DETAILED DESCRIPTION OF THE PREFERRED EMBODIMENTS

In one embodiment, the present invention provides systems and methods for modeless operation of a digital camera, such as a digital still camera, for both video image capture and still image capture. Modeless operation of the camera in this embodiment enables a user to capture still images and video images without having to change a mode of the camera between a still image capture mode and a video image capture mode. Modeless operation of video image capture and still image capture visually communicates the video image capture feature to a customer at a point of sale, enables a user to select between video image capture and still image capture immediately while framing a subject image and without taking the user's eye from the viewfinder, and enables a user to more easily understand the requirements for capturing video images or still images. In one example, the systems and methods of the present invention include a still image capture trigger and a separate, dedicated video image capture trigger to enable the modeless operation.

Because the digital camera has a still image capture trigger and a separate, dedicated video image capture trigger, a user may capture a still image or video images at any time without having to operate mechanical dials or other controllers to change between a still image capture mode and a video image capture mode prior to capturing the images. A user does not have to turn a mode dial or other image capture mode selector to select between capturing a still image and capturing video images while operating the digital camera. Additionally, the user does not have to identify whether the digital camera is set to a still image capture mode or a video image capture mode upon power-up. For example, in some prior cameras, a mode controller may be a mechanical device that is set to one mode or the other. The modes may include still image capture mode or video image capture mode. When using these cameras, the user may have to identify and change the mechanical mode setting prior to capturing an image.

In another embodiment, the present invention provides a first trigger and a second trigger. Each trigger is configurable and may be assigned to a capture mode, including capturing a still image, capturing a sequence of still images, capturing video images, or capturing audio. The assignment of a capture mode to each trigger may be completed at a configurable time, including at manufacture or prior to attempting capture of images or audio. Therefore, modeless operation of the camera in this embodiment enables a user to use the first trigger and the second trigger to capture images or audio at any time after the triggers are assigned to a capture mode without later having to operate mechanical dials or other controllers to change modes for a single trigger.

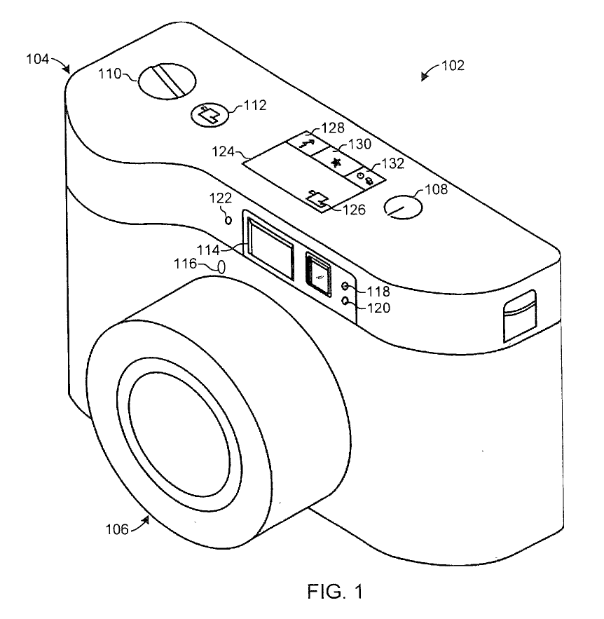

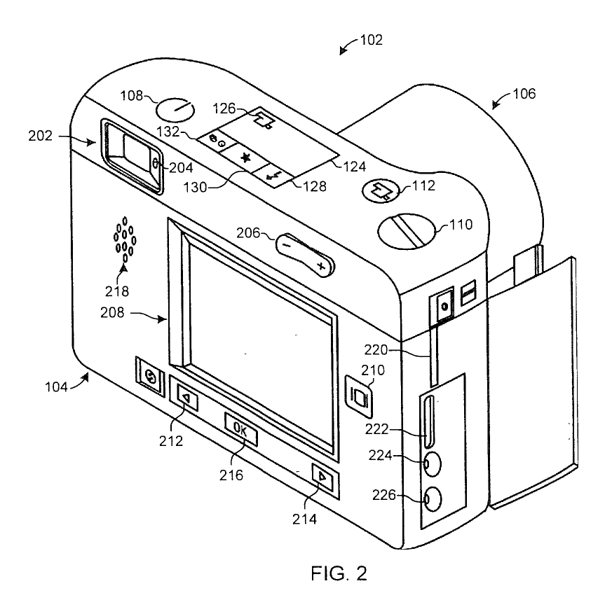

FIGS. 1 and 2 depict an exemplary embodiment of a digital camera in accordance with the present invention. FIG. 1 depicts a perspective view of the top and front of the digital camera 102. FIG. 2 depicts a perspective view of the top and back of the digital camera 102. It will be appreciated that the systems and methods of the present invention may be used with digital cameras, camcorders, and other image capturing devices.

Referring now to FIG. 1, the digital camera 102 generally includes a housing 104 with a photographic lens system 106 configured to facilitate the capture of images as either video images or still images. The lens system 106 may include one or more lenses, an image sensor, such as a charge coupled device or a complimentary metal oxide semiconductor image sensor, a timing generator, and an analog front end as is known in the art. The lens system 106 also may include a mechanical shutter and/or an electrical shutter and a motor to drive the mechanical shutter.

The digital camera 102 also includes a power controller 108, a still image capture trigger 110, and a video image capture trigger 112. In one embodiment, the power controller 108, the still image capture trigger 110, and the video image capture trigger 112 are a power button, a shutter button, and a video capture button, respectively.

The power controller 108 is configured to turn the power to the digital camera 102 on and off. In one embodiment, the power controller 108 is a two-state button in which power is turned on in one state, and power is off in the other state. In one example, the power controller 108 includes a push-on, push-off button with which power is turned on when the button is pushed on and turned off when the button is pushed off. Other types of controllers may be used for the power button

The still image capture trigger 110 may be configured to trigger one or more signals corresponding to one or more selectable states. In one embodiment, the still image capture trigger 110 is a button configured with two states including a non-image capturing state and an image capturing state. In this embodiment, when the still image capture trigger 110 is pressed, the still image capture trigger triggers the image capturing state. When the still image capture trigger 110 is not pressed, the still image capture trigger does not trigger the image capturing state. In one example of this embodiment, the still image capture trigger 110 is configured to trigger a single still image capture. In another example of this embodiment, the still image capture trigger 110 is configured to trigger an image capture sequence. The number of images captured in the sequence is configurable. In one example, a sequence of four images is captured. However, greater of fewer images may be captured. Alternately, the digital camera 102 may capture images continuously until the trigger is released or until memory becomes full.

In another embodiment, the still image capture trigger 110 may trigger one or more signals corresponding to a button configured with three states. In this embodiment, the still image capture trigger 110 may generate signals corresponding to a mode triggering state and an image capturing state and not generate a signal corresponding to a non-image capturing state. For example, if the still image capture trigger 110 is not pressed and is left in a first position, a still image is not captured. If the still image capture trigger 110 is placed in a second position, such as a button pressed halfway, the digital camera 102 may operate in a selected mode, such as an automatic focus mode in which a subject image is automatically focused. If the still image capture trigger 110 is placed in a third position, such as a button pressed all the way, the digital camera 102 captures one or more still images.

The video image capture trigger 112 is a dedicated video image capture trigger separate from the still image capture trigger 110. The video image capture trigger 112 is configured to trigger capture of video images. In one embodiment, the video image capture trigger 112 is a two state controller, such as two state button. In this embodiment, if the video image capture trigger 112 is in a first state, such as a button that is not pressed, video capture of images is not triggered. If the video image capture trigger 112 is placed in a second state, such as a button that is pressed, video capture of images is triggered.

The video image capture trigger 112 may include other types of controllers in other embodiments. For example, in another embodiment, the video image capture trigger 112 may include a three state controller in which video capture is not triggered in a first state, a mode operation, such as an automatic focus, is triggered in a second state, and video image capture is triggered in a third state.

In one embodiment, if the still image capture trigger 110 and the video image capture trigger 112 both are pressed, the first to be pressed is triggered. The second to be pressed essentially is ignored. In another embodiment, if the video image capture trigger 112 is pressed, and the still image capture trigger 110 subsequently is pressed while video images are captured, the digital camera 102 may capture a high resolution still image.

The digital camera 102 optionally may be configured with a light emitting unit 114, a microphone 116, a capture status indicator 118, metering elements 120 and 122, and a status display 124. Other elements may exist.

The light emitting unit 114 may be a strobe or flash and is configured to be capable of emitting a light to illuminate a subject during an image capture operation. The light emitting unit 114 may be enabled or disabled at various times.

The microphone 116 is configured to facilitate recording audio during an image capture operation or for other audio capture operations. In one embodiment, the microphone 116 is configured to facilitate recording audio alone.

The capture status indicator 118 indicates a status of a capture operation. In one embodiment, the capture status indicator 118 comprises a light configured to generate a solid color when the digital camera 102 is capturing video images. In another embodiment, the capture status indicator 118 is configured to generate a blinking light when a self-timer is activated.

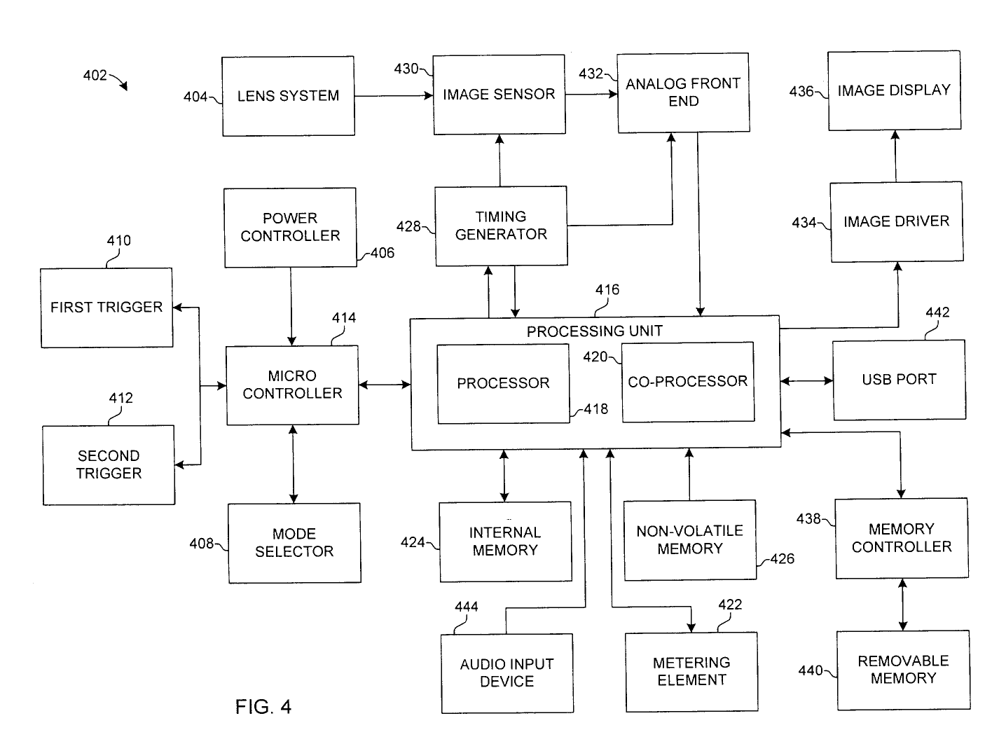

The metering elements may include a photo metering element 120 and a color metering element 122. The metering elements are optional and are not included in the digital camera 102 in some embodiments. In one embodiment, an image sensor is configured to provide the brightness and color information used to make exposure adjustment, white balance, color processing, and/or gamma processing, where performed (see FIG. 4).

The photo metering element 120 detects and/or measures quantities of light from a subject and from a periphery of the subject. The photo metering element 120 may generate the results of the detection and/or measurement to a photo metering circuit (not shown) configured to process data from the photo metering element to create photo metering data and to transmit the photo metering data to a processing unit (see FIG. 4) for processing. The photo metering 120 element is optional.

The color metering element 122 detects and/or measures color spectrum data (sometimes referred to as temperatures) of a subject and from a periphery of the subject. The color metering element 122 may generate the results of the detection and/or measurement to a color metering circuit (not shown) to be converted to color metering data. The color metering data then may be transmitted to a processing unit (see FIG. 4) for processing. The color metering element 122 is optional.

A status display 124 may be configured to display one or more camera settings and/or operating statuses. In one embodiment, the status display 124 is configured to display a capture symbol to indicate a capture operation being performed. For example, the status display 124 may be configured to display a video capture symbol 126 while the video image capture operation is being performed. In other examples, an audio capture symbol, a still image capture symbol, or a sequence image capture symbol may be displayed to indicate performance of an audio capture operation, a still image capture operation, or a sequence image capture operation, respectively. In other embodiments, the status display 124 may display one or more numbers, characters, or other symbols to indicate active red-eye reduction, whether the strobe is on or off, whether the strobe is set to automatic, the selected image quality, the number of images that may still be taken, whether a self-timer is active, whether a burst feature is active, a battery condition, or if memory for the camera is available, such as whether a memory card is in the camera.

Referring now to FIG. 2, a viewfinder 202 may be used to frame the subject to be captured. A status indicator 204 may be provided in the viewfinder 202. The status indicator 204 is configured to provide a status of the digital camera 102 through one or more indicator means.

In one embodiment, the status indicator 204 comprises an indicator light configured to blink, remain off, or remain a solid color, each indicating a different status. Other status indicators may include multiple lights, each having the same or a different color and configured to blink, remain on, and/or remain off, each to represent one or more statuses. In another embodiment, a text or symbol readout or display may be provided as the status indicator 204.

In one example, the status indicator 204 generates a solid green light to indicate that the camera is recording video or ready to take a still picture, generates a blinking green light to indicate that the camera is unable to focus or has a long exposure, generates a blinking yellow light to indicate that the camera is charging the flash or saving images to memory, and generates a blinking red light to indicate that the camera is starting up, charging the battery, sending/receiving data via a universal serial bus (USB) port, counting down a self-timer, or that there is an error with the digital camera 102.

A zoom in/out controller 206 enables a user to cause the photographic lens system 106 to zoom in on a subject or zoom out from a subject. The zoom in/out controller 206 is optional. In some embodiments, the zoom in/out controller is included only if the photographic lens 106 has a zoom in/out capability.

An image display 208 is configured to generate image data of a subject for viewing by a user. In one embodiment, the image display 208 is configured to generate a preview of the subject image or images to be captured prior to actually capturing the image or images. In another embodiment, a still image or video images that have been captured may be reviewed using the image display 208. In another embodiment, camera operational information and/or menu information may be generated to the image display for viewing and/or selection.

An image display controller 210, such as an image display button, is configured to turn the image display on or off. The image display controller 210 also may be configured to turn on a preview mode.

Various controllers may be included to select one or more camera settings or operational modes. For example, the digital camera 102 may include controllers, such as a strobe button 128 configured to select a flash/strobe setting, a quality button 130 configured to select one or more image quality settings, and a self-timer/burst button 132 configured to set a self-timer or a burst feature.

Menu controllers may be provided for the digital camera 102. In one embodiment, the menu controllers include right and left arrow buttons 212 and 214 configured to enable moving through menu options and navigating through images and an OK button 216 configured to enable selection of a playback mode, selection of a menu, and selection of menu options.

The digital camera also may include a speaker 218 configured to generate audio, such as audio associated with a video clip of captured video images or audio clips captured alone or with still images. Other sounds may be generated by the speaker 218.

A memory card slot 220 or other memory connector configured to communicate with removable memory is included in some embodiments. In one embodiment, the memory card slot 220 is configured to receive a removable media memory card (not shown). A removable memory controller (see FIG. 4) controls storage and retrieval of image data to and from the removable memory.

A USB port 222 may be included to communicate data between the digital camera 102 and a processor, such as a computer or printer. An audio/video connector 224 may be provided to transmit data to a listening and/or viewing device, such as a monitor or television. A power adapter 226 also may be provided and configured to receive power, such as alternating current power, via a power connector.

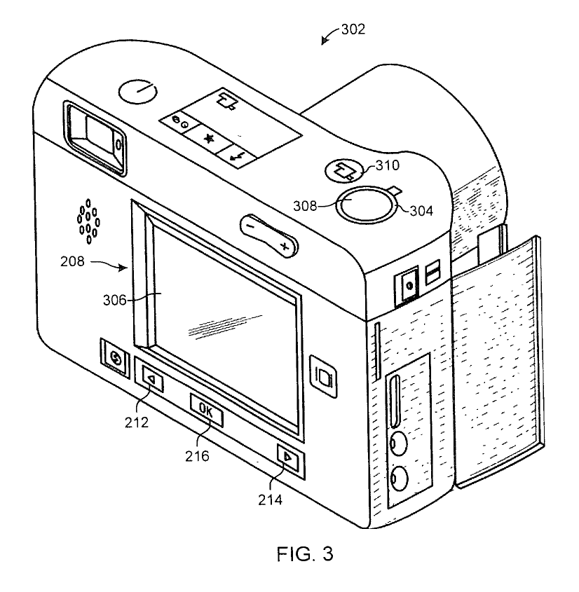

FIG. 3 depicts an exemplary embodiment of another digital camera 302. The digital camera 302 of FIG. 3 is similar to the digital camera 102 of FIGS. 1-2. In one embodiment of FIG. 3, the digital camera 302 of FIG. 3 comprises a mechanical mode selector 304. In other embodiments, the digital camera 302 may include a menu driven mode selector 306 displayable on the image display 208. A user may use the left and right arrow buttons 212 and 214 and the OK button 216, or other controllers, to navigate through one or more menus or to select an operating mode from a menu option.

The mode selectors 304 or 306 may be configured to enable a user to select from a variety of operating modes, including one or more capture modes. In one embodiment, the modes selectors 304 or 306 enable a user to assign a first capture mode to a first trigger 308 and a second capture mode to a second trigger 310. In one example, the mode selectors 304 or 306 enable a user to assign a still image capture mode to the first trigger 308 and a video image capture mode to the second trigger 310. In another example, the mode selectors 304 or 306 enable a user to assign a sequence image capture mode to the first trigger 308 and an audio capture mode to the second trigger 310. Other modes may be selected.

FIG. 4 depicts an exemplary embodiment of a digital camera of the present invention. The digital camera 402 of FIG. 4 comprises a lens system 404, a power controller 406, a mode selector 408, a first trigger 410, a second trigger 412, and a micro controller 414.

The lens system 404 is configured to facilitate the capture of images. The lens system may include, for example, a photographic lens, an aperture, an aperture motor to drive the aperture, a shutter, and a shutter motor to drive the shutter. In one embodiment, the lens system 404 includes an optical zoom lens. In this embodiment, the lens system 404 also may be configured with a zoom motor to drive the zoom of the zoom lens.

In the embodiments in which an aperture is present in the lens system 404, the aperture may be set to a first position, such as F2.8, for still image capture and set to a second position, such as F8, for video image capture. The F-numbers may vary further with optical zoom. The F-number may be identified, for example, as a ratio of focal length of a photographic lens to the effective diameter of the lens opening. Typically, a smaller F-number means more light passes through the lens, and a larger number means less light passes through the lens.

In one embodiment, a shutter may be present or desirable for the lens system 404. In one example of this embodiment, the digital camera 402 is configured with a mechanical shutter for still image capture and an electronic shutter for video image capture. In another example, an electronic shutter may be used for still image capture and video image capture.

The power controller 406 is configured to turn power on and off to the digital camera. In one embodiment, the power controller 406 is a two-state button in which power is turned on in one state, and power is off in the other state. In one example, the power controller 406 includes a push-on, push-off button with which power is turned on when the button is pushed on and turned off when the button is pushed off. In another example, when the power controller 406 is triggered, turn-off of the camera is delayed, and post-processing of images and other data is completed prior to the actual shutdown of the digital camera 402. Other types of controllers may be used for the power button.

The mode selector 408 is configured to enable selection of various operational settings and modes for the digital camera, including capture modes for capture operations. In one embodiment, the mode selector is a menu driven mode selector in which modes and operational settings are displayed on a display and selected to set operational modes or settings. In another embodiment, the mode selector 408 is a mechanical selector, such as a knob or button, used to select operational settings and modes. Other examples exist. The mode selector 408 is optional.

The first trigger 410 is configured to trigger one or more capture operations of the digital camera 402 or another image capture device for one or more capture modes. The first trigger 410 may be configured, for example, to trigger a capture operation for a single still image capture, capture of a sequence of still images, video image capture, audio capture, and/or other operations.

In some embodiments, the first trigger 410 may be configured to enable a secondary capture operation, such as an automatic focus operation. For example, the first trigger 410 may be configured as a three-state button in which a still image capture operation is not triggered if the button is not pressed, the still image capture operation is triggered if the button is pressed all the way, and an automatic focus operation is triggered if the button is pressed halfway.

In another example, the first trigger 410 may be configured as a three-state button in which a still image capture operation is not triggered if the button is not pressed, the still image capture operation is triggered if the button is pressed all the way, and an audio capture operation is triggered if the button is pressed halfway. In this example, the audio may be continuously captured when the button is pressed all the way and released, so that audio is captured before and/or after the still image is captured. In one embodiment, the audio capture operation stops when the button again is pressed halfway or when memory is expended. In another embodiment of this example, the audio capture operation is initiated when the button is pressed halfway, but audio is not captured until the button is pressed all the way, and the audio capture operation stops when the button is released or when memory is expended. Other examples and other triggers may exist. In addition, the automatic focus operation or other operation may be triggered with another controller.

In yet another example, the first trigger 410 may be configured as a three-state button in which a still image capture operation is not triggered if the button is not pressed, the still image capture operation is triggered if the button is pressed all the way, and an automatic focus operation is triggered if the button is pressed halfway. In this example, the second trigger 412 may be configured as a three-state button in which a video image capture operation is not triggered if the button is not pressed, the video image capture operation is triggered if the button is pressed all the way, and an audio capture operation is triggered if the button is pressed halfway.

The second trigger 412 is configured to trigger one or more capture operations of the digital camera 402 or another image capture device for one or more capture modes. The second trigger 412 may be configured, for example, to trigger a capture operation for a single still image capture, capture of a sequence of still images, video image capture, audio capture, and/or other operations.

In some embodiments, the second trigger 412 may be configured to enable a secondary operation, such as an automatic focus operation. For example, the second trigger 412 may be configured as a three-state button in which a video image capture operation is not triggered if the button is not pressed, the video image capture operation is triggered if the button is pressed all the way, and an automatic focus operation is triggered if the button is pressed halfway.

In another example, the second trigger 412 may be configured as a three-state button in which a video image capture operation (not including audio) is not triggered if the button is not pressed, the video image capture operation is triggered if the button is pressed all the way, and a video image capture and audio capture operation is triggered if the button is pressed halfway. Other examples and other triggers may exist. In addition, the automatic focus operation or other operation may be triggered with another controller.

The first and second triggers 410 and 412 may be configurable through a mode selector, such as a menu selection or a mechanical controller, or configured upon manufacture. Also, the first and second triggers 410 and 412 may be configurable through a personal computer or other computer connected to the digital camera 402. Additionally, the first and second triggers 410 and 412 may be configurable through a remote, such as an infrared remote. Other devices and methods may be used for configuration of the first and second triggers 410 and 412.

In one embodiment, the first and second triggers 410 and 412 are configurable through the mode selector 408. In one example, the first trigger 410 is configured as a still image capture trigger, and the second trigger 412 is configured as a video image capture trigger. In another example, the first trigger 410 is configured as a still image capture trigger, and the second trigger 412 is configured as a sequence image capture trigger. In still another example, the first trigger 410 is configured as a still image capture trigger, and the second trigger 412 is configured as an audio capture trigger. In another example, the first trigger 410 is configured as a sequence image capture trigger, and the second trigger 412 is configured as a video image capture trigger. In yet another example, the first trigger 410 is configured as a video image capture trigger, and the second trigger 412 is configured as an audio capture trigger.

The micro controller 414 is configured to receive signals from the power controller 406, the mode selector 408, the first trigger 410, and the second trigger 412. The micro controller 414 also is configured to receive signals from a zoom in\out controller (see FIG. 2) and other various controllers (see FIG. 2), such as a flash controller to select a flash\strobe setting, a quality controller to select one or more image quality settings, and a self timer\burst controller configured to set a self timer or a burst feature. The micro controller 414 also may be configured to control a strobe (see FIG. 4) to generate a strobe or other light and a status display (see FIG. 4) configured to display setting information, status information, and other operational information. In addition, the micro controller 414 controls focus if the digital camera 402 has a focus mode. In some embodiments in which a digital camera has an aperture and a shutter in the lens system 404, the micro controller 414 controls the aperture control and the shutter control.

The micro controller 414 is configured to transmit data to the processing unit 416. This data may include, for example, mode selection data, shutter control data, automatic focus data, power on/off data, zoom operation data, strobe operation data, other controller data, and other operational, mode, and setting data. The micro controller 414 also may receive data, including operation data, instruction data, and setting data, from the processing unit 416. This data may include, for example, strobe control data, status display data, and other operational data.

The digital camera 402 also includes a processing unit 416, which has a processor 418 and a co-processor 420 in the embodiment of FIG. 4, an optional metering element 422, internal memory 424, non-volatile memory 426, a timing generator 428, a capture device, such as an image sensor 430, an analog front end (AFE) 432, an image driver 434, an image display 436, a memory controller 438, a removable memory 440, a USB port 442, and another capture device, such as an audio input device 444.

The processing unit 416 is configured to control the operation of the digital camera 402, including image capture, audio capture, image processing, audio processing, data storage and retrieval, and data display, including audio data generation to one or more speakers. In the embodiment of FIG. 4, the processing unit 416 comprises a processor 418 and a co-processor 420. In other embodiments, the processing unit 416 may include a single processor or multiple processors.

In one embodiment, the processing unit 416 is configured to process image data and/or audio data with a compression algorithm. The data then may be stored.

In one example, the processing unit 416 is configured to compress image data with a linear to exponential compression algorithm, such as A-law or μ-law compression. In another example, still images are compressed using joint photographic experts group (JPEG) compression and stored in an exchangeable image file format (EXIF) file. In another example, a sequence of still images is compressed using JPEG compression and stored as separate files, such as with the EXIF file format. In still another example, video is compressed and stored using the motion JPEG or moving pictures experts group (MPEG) format. In another example, the processing unit 416 is configured to process audio data with a compression algorithm, such as an MPEG layer-3 (MP3) compression algorithm. In yet another example, audio for still images is compressed using Interactive Multimedia Association (IMA) adaptive differential pulse code modulation (ADPCM). In this example, the compressed data can be stored in an EXIF file with image data or stored separately. In still another example, audio for video images is compressed using MPEG layer-1 compression. In another example, MPEG layer-2 or MPEG layer-4 compression may be used. In each example, the data may be stored in internal memory 424 or on removable memory 440.

In one embodiment, the co-processor 420 performs the compression operation, if one is selected. The compressed data then may be generated to the removable memory 440 via the memory controller 438 or to internal memory 424.

If the image data and/or audio data is compressed with a compression algorithm, and if the compressed image data and/or audio data subsequently is stored on the removable memory 440, the processing unit 416 may be configured to retrieve the image data and/or audio data and uncompress the image data and/or audio data using the same compression algorithm used to compress the image data and/or audio data. In one embodiment, the co-processor 420 may access the image data and/or audio data from the removable memory 440 via the memory controller 438, uncompress the image data and/or audio data using the same compression algorithm with which the image data and/or audio data was compressed, and perform other processing on the image data and/or audio data if needed. For example, if image data was compressed using a JPEG compression algorithm prior to storage, the image data may be recovered according to the JPEG algorithm.

The processor 418 is configured to transmit data to, and receive data from, other components of the digital camera 402. For example, the processor 418 communicates control and operation data with the micro controller 414, and the processor communicates with the timing generator 428 to enable timing signals to be generated to the image sensor 430, the AFE 432, and back to the processing unit 416. The processor 418 also communicates with the internal memory 424 for the temporary storage and retrieval of data. The processor 418 communicates with the non-volatile memory 426 to retrieve, load, and process programming and instructions required to operate the digital camera 402. Additionally, the processor 418 communicates with the image driver 434 so that images may be displayed on the image display 436. The processor 418 also communicates with the memory controller 438 so that image data and/or audio data may be stored on, and retrieved from, the removable memory 440. In addition, the processor 418 controls transfer of data via the USB port 442, and controls receiving audio data from the audio input device 444.

The co-processor 420 performs processing intensive operations. The co-processor 420 may be configured to perform image processing and/or audio data processing, such as compression, white balance, and exposure adjustment. The co-processor 420 may perform other data processing operations.

The metering element 422 may include a photo metering element, a color metering element, or another image sensor. The metering element is optional and is not included in the digital camera 402 in some embodiments. In one embodiment, the image sensor 430 is configured to provide the brightness and color information used for exposure adjustment, white balance, color processing, and/or gamma processing, where performed.

A photo metering element detects and/or measures quantities of light from a subject and from a periphery of the subject. The photo metering element or another element may process data from the photo metering element to create photo metering data and transmit the photo metering data to a processing unit 416 for processing. The photo metering element is optional.

A color metering element detects and/or measures color spectrum data (sometimes referred to as temperatures) of a subject and from a periphery of the subject. The color metering element or another element may process data from the color metering element to create color metering data and transmit the color metering data to a processing unit 416 for processing. The color metering element is optional.

The internal memory 424 may include volatile memory and/or nonvolatile memory. In one embodiment, the internal memory 424 includes memory that may be accessed quickly by the processor 418 while operating. The internal memory 424 communicates with the processor 418 to quickly receive and store data from, and read data to, the processor 418 during operation. In one embodiment, the internal memory 424 includes synchronous dynamic random access memory (SDRAM). In another embodiment, the internal memory 424 includes internal non-volatile memory to which image data and/or audio data is stored.

The non-volatile memory 426 is configured to retain data when the power to the digital camera 402 is off. In one embodiment, the non-volatile memory 426 includes flash memory.

The timing generator 428 generates timing signals to the image sensor 430 and the AFE 432. The timing signals cause the charges accumulated by the detectors in the image sensor 430 to be read to the AFE 432. The timing generator 428 is capable of flushing the detectors in the image sensor 430 to discharge any charge previously accumulated on the detectors within the image sensor 430.

The image sensor 430 detects amounts of light and colors to capture images. In one embodiment, the image sensor 430 is configured to detect color metering data, photo metering data, and/or other brightness and/or color information used for exposure adjustment, white balance, gamma processing, and/or color processing. In one example of this embodiment, other metering elements are not included in the digital camera 402. In some embodiments, the image sensor 430 may be a charge coupled device (CCD), a complimentary metal oxide semiconductor (CMOS) image sensor, and/or other image sensors.

A CCD includes a series of detectors that are sensitive to a color and a corresponding amount of light. Each detector is equivalent to one pixel. In one embodiment, the CCD detects red, green, or blue at any one pixel.

Each detector accumulates a charge that is representative of the amount of light for one pixel. The value of the charge may be transmitted to the AFE 432 in an electrical signal as data. The data from the pixels represents the image data from a subject image for which a still image or video image is to be captured.

The CCD's pixels are arranged in a series of horizontal rows and vertical columns. The CCD has a horizontal driver (HD) and a vertical driver (VD) that control the transmission of data by the rows and columns of these pixels to the AFE 432.

The CCD is driven by the timing generator 428. The timing signals received from the timing generator 428 cause the CCD to read image data pixel by pixel to the AFE 432. The pixels normally are read by row and then serially by each pixel in the row. Once a row has been read, a next row is read. The timing specifies the order and timing in which these rows of pixels are read to the AFE 432. Therefore, the timing signals from the timing generator 428 determine how fast the pixel data is shifted from pixel to pixel and determines what row and pixel is being read from the CCD to the AFE 432.

A CMOS image sensor measures the rate that photons cause conduction across a junction. In one example, a measured charge is placed on a reversed-biased junction of a CMOS sensor, which has capacitance, and the change in voltage is measured after exposure. The voltage change is correlated to an amount of light for a color. In one embodiment, the CMOS image sensor has rows and columns of pixels. Image data is read from the pixels by row in parallel to a set of column amplifiers. The column amplifier then is read out either serially or partially in parallel. In this embodiment, the read out rate is governed by timing signals from the timing generator.

In another example, the image sensor 430 is configured with a P-Intrinsic-N (PIN) type diode array. Each diode in the array may include a P region, an N region, and a lightly doped or undoped intrinsic region in between. In this example, a CMOS array is produced with the PIN diode array.

In one embodiment, the image sensor 430 has at least two shift-out modes, including a normal mode and a rapid read-out mode. In the normal mode, every row is shifted out. In the rapid read-out mode, every Nth row is shifted out. In one example, the normal mode is used with the capture of a still image and the capture of a sequence of still images, while the rapid read-out mode is used with capture of video images.

In one embodiment, the image sensor 430 is configured to read out image data at a first resolution, such as a lower resolution, when the first or second trigger 410 or 412 is not triggered and a second resolution, such as a higher resolution, when the first or second trigger is triggered. In other embodiments, the image sensor 430 may be configured to read out image data at a single resolution.

The AFE 432 receives the pixel data from the image sensor 430 as analog data. The AFE 432 processes the data by converting the data from analog data to digital data. In one embodiment, the AFE 432 includes a correlated double sampler (CDS) configured to sample the analog data, an automatic gain controller (AGC) configured to adjust the amplification/gain of the sampled data, and an analog to digital converter (ADC) configured to convert the analog signals to digital data signals. The AFE 432 then transmits the digital signals to the processing unit 416. The sampling and gain adjustment of the CDS and the AGC are intended to reduce or eliminate noise from the data signals received from the image sensor 430.

The image driver 434 drives the image display 436. The image driver 434 receives image data from the processing unit 416, sizes the image data for the size of the image display 436, and generates the image data to the image display in a format compatible with the image display.

The image display 436 generates image data and other data to be viewed by the user. The image display 436 may provide captured images of a subject and provide operational and setting information, such as menu options.

The memory controller 438 controls the storage and retrieval of data to and from the removable memory 440. The memory controller 438 is configured to receive instructions from the processing unit 416 for storage of data in the removable memory 440 and to store the data. The memory controller 438 also is configured to receive instructions from the processing unit 416 for the retrieval of data from the removable memory 440, to retrieve the data, and to transmit the data to the processing unit.

The removable memory 440 is memory on which image data and/or audio data may be stored and/or from which image data and/or audio data may be retrieved. The removable memory 440 may include, for example, a removable media card, a removable media stick, or another removable media.

The USB port 442 is a port via which data is transferred from the digital camera 402. In some embodiments, the USB port 442 may be configured to receive data into the digital camera 402. The USB port 442 is configured to receive a connector to transfer or receive the data.

The audio input device 444 facilitates the capture of audio. The audio input device 444 may be, for example, a microphone controlled by the processing unit 416. In another embodiment, the audio input device 444 is configured to generate the audio data to the processing unit 416. In another embodiment, the audio input device 444 transmits the audio data to an analog to digital converter that converts the audio data to a digital form. The digital audio data then is transmitted to the processing unit 416.

In one example, the digital camera 402 of FIG. 4 operates as follows. When the power controller 406 is pressed to turn the digital camera 402 on, the processing unit 416 retrieves the operating programming from the non-volatile memory 426 and loads it in the internal memory 424. If a mode is selected using the mode selector 408, the processor 418 places the digital camera 402 in the appropriate operating mode. In this example, the first trigger 410 is configured to trigger still image capture, and the second trigger 412 is configured to trigger video image capture.

If the first trigger 410 is triggered, the image sensor 430 captures a still image, such as of a subject, via the lens system 404. If the second trigger 412 is triggered, the image sensor 430 captures video images via the lens system 404. In either case, the image sensor 430 transmits the captured image data to the AFE 432 according to timing signals received by the timing generator 428. The AFE 432 converts the image data to a digital form and transmits the image data to the processing unit 416 for processing.

The processor 418 collects metering data from the image sensor 430. The metering data may include photo metering data and/or color metering data to be used with image processing, such as compression, white balance, and exposure adjustment. The metering data also may be used prior to image capture. For example, the metering data may be processed and used to adjust the gain control in the CCD, the lens diaphragm opening of an aperture, the use or level of a strobe, and other operational parameters for balancing color and white balance when an image is captured. The processor 418 provides the image data and the metering data to the co-processor 420.

The co-processor 420 image processes the image data with the metering data, such as with image processing for exposure adjustment and white balance, and transmits the processed image data to the image driver 434 for display on the image display 436. Additionally, the co-processor 420 may image process the image data with a compression algorithm prior to storing the image data. The co-processor 420 generates this processed image data to the memory controller 438 for storage on the removable memory 440.

Those skilled in the art will appreciate that variations from the specific embodiments disclosed above are contemplated by the invention. The invention should not be restricted to the above embodiments, but should be measured by the following claims.

What is claimed is:

1. A digital camera comprising:
a still image capture trigger configured to trigger still image capture;
a video image capture trigger configured to trigger video image capture;
an image sensor configured to capture still image data when the still image capture trigger is triggered and to capture video image data when the video image capture trigger is triggered; and
a processing unit configured to receive and to image process the still image data and the video image data.

2. The digital camera of claim 1 further comprising a status display configured to display a video image capture symbol when the video image data capture is being performed.

3. The digital camera of claim 1 wherein the video image capture trigger further is configured to enable stopping the video image capture.

4. The digital camera of claim 1 further comprising at least one member of a group consisting of:
a video capture timer configured to stop the video image data capture when a selected period of time has elapsed after the video image data capture is initiated; and
a video capture memory controller configured to stop the video image data capture when a selected amount of memory has been used for the video data image capture.

5. The digital camera of claim 1 wherein the image sensor comprises at least one member of a group consisting of a charge coupled device and a complimentary metal oxide semiconductor image sensor.

6. A digital camera comprising:
a first trigger configured to enable triggering a first capture operation to capture first data;
a second trigger configured to enable triggering a second capture operation to capture second data; and
a processing unit electronically coupled to the first trigger and the second trigger and configured to initiate the first capture operation to capture the first data when the first trigger is triggered, to initiate the second capture operation to capture the second data when the second trigger is triggered, and to receive and to process the first data and the second data.

7. The digital camera of claim 6 further comprising:
a mode selector configured to assign the first capture operation to the first trigger and to assign the second capture operation to the second trigger;
wherein the first capture operation comprises at least one member of a group consisting of a first still image capture to capture at least a first still image, a first sequence image capture to capture at least a first sequence of images, a first audio capture to capture first audio, and a first video image capture to capture first video images; and
wherein the second capture operation comprises at least one member of a group consisting of a second still image capture to capture at least a second still image, a second sequence image capture to capture at least a second sequence of images, a second audio capture to capture second audio, and a second video image capture to capture second video images.

8. The digital camera of claim 6 wherein the first capture operation to capture first data comprises at least one member of a group consisting of a still image capture to capture still image data, a sequence image capture to capture sequence image data, a video image capture to capture video image data, and an audio capture to capture audio data.

9. The digital camera of claim 6 wherein the second capture operation to capture second data comprises at least one member of a group consisting of a still image capture to capture still image data, a sequence image capture to capture sequence image data, a video image capture to capture video image data, and an audio capture to capture audio data.

10. The digital camera of claim 6 wherein if an audio capture to capture audio data is configured for at least one member of a group consisting of the first capture operation to capture first data and the second capture operation to capture second data, the digital camera further comprises:
an audio input device configured to capture the audio data;
wherein the processing unit is electronically coupled to the audio input device and is configured to initiate capture of the audio data upon triggering of the audio capture and to receive and to process the audio data.

11. The digital camera of claim 6 further comprising:
an image sensor configured to capture still image data when the first capture operation comprises a still image capture, to capture sequence image data when the first capture operation comprises a sequence image capture, and to capture video image data when the first capture operation comprises video image capture;
wherein the processing unit is configured to image process the still image data when the first capture operation comprises a still image capture, to image process the sequence image data when the first capture operation comprises a sequence image capture, and to image process the video image data when the first capture operation comprises video image capture.

12. The digital camera of claim 6 further comprising:
an image sensor configured to capture still image data when the second capture operation comprises a still image capture, to capture sequence image data when the second capture operation comprises a sequence image capture, and to capture video image data when the second capture operation comprises video image capture;
wherein the processing unit is configured to image process the still image data when the second capture operation comprises a still image capture, to image process the sequence image data when the second capture operation comprises a sequence image capture, and to image process the video image data when the second capture operation comprises video image capture.

13. The digital camera of claim 6 wherein:
the first capture operation to capture first data comprises still image capture to capture still image data;
the second capture operation to capture second data comprises audio capture to capture audio data; and
the digital camera further comprises a first capture device configured to capture the still image data when the first trigger is triggered and a second capture device configured to capture the audio data when the second trigger is triggered.

14. The digital camera of claim 6 wherein the first capture operation comprises video image capture and the first trigger comprises a video image capture trigger, wherein the digital camera further comprises at least one member of a group comprising:
a video capture timer configured to stop the video image capture when a selected period of time has elapsed after the video image capture is initiated; and
a video capture memory controller configured to stop the video image capture when a selected amount of memory has been used for the video image capture.

15. The digital camera of claim 6 further comprising at least one status display configured to display a capture symbol to indicate when the first capture operation is being performed and when the second capture operation is being performed.

16. A method for configuring a digital camera for capturing video images and at least one still image, the method comprising:
providing, on the digital camera, a still image capture trigger configured to enable triggering still image capture;
providing, on the digital camera, a video image capture trigger separate from the still image capture trigger, the video image capture trigger configured to enable triggering video image capture;
providing, on the digital camera, an image sensor configured to capture still image data when the still image capture trigger is triggered and to capture video image data when the video image capture trigger is triggered; and
providing, on the digital camera, a processing unit configured to receive and to image process the still image data and the video image data.

17. The method of claim 16 wherein the step of providing, on the digital camera, the image sensor comprises providing, on the digital camera, at least one member of a group consisting of a charge coupled device and a complimentary metal oxide semiconductor image sensor.

18. The method of claim 16 further comprising the step of configuring the video image capture trigger to enable stopping the video image capture.

19. The method of claim 16 further comprising the step of providing, on the digital camera, a display and configuring the display to display a video image capture symbol when the video image capture is performed.

20. The method of claim 16 further comprising the step of configuring the digital camera to stop the video capture using at least one member of a group selected from: a video capture timer configured to stop the video image capture when a selected period of time has elapsed after video image capture is initiated and a video capture memory controller configured to stop the video image capture when a selected amount of memory has been used for the video image capture.

21. A method for operating a digital camera configured with a first capture trigger, a second capture trigger, an image sensor, and a processing unit, the method comprising:
capturing still image data at the image sensor for at least one still image upon trigger of the first capture trigger;
capturing video image data at the image sensor upon trigger of the second capture trigger; and
image processing the still image data and the video image data with the processing unit.

22. The method of claim 21 wherein the image processing step comprises compressing the still image data and the video image data.

23. The method of claim 21 wherein the digital camera further comprises at least one member of a group consisting of internal memory and removable memory and the method further comprises storing the image processed still image data and video image data on the at least one member of the group consisting of internal memory and removable memory.

24. The method of claim 21 wherein the digital camera further comprises a display and the method further comprises generating for display at least one member of a group consisting of the still image data and the video image data.
